(19) United States
(12) Patent Application Publication
(10) Pub. No.: US 2017/0244736 A1
(43) Pub. Date: Aug. 24, 2017

(54) METHOD AND SYSTEM FOR MITIGATING MALICIOUS MESSAGES ATTACKS

(71) Applicant: Ironscales Ltd., Givatayim (IL)

(72) Inventor: Eyal Benishti, Givatayim (IL)

(73) Assignee: Ironscales Ltd., Givatayim (IL)

(21) Appl. No.: 15/581,336

(22) Filed: Apr. 28, 2017

Related U.S. Application Data
(63) Continuation-in-part of application No. PCT/IL2015/051055, filed on Oct. 28, 2015.

(30) Foreign Application Priority Data
Oct. 30, 2014 (IL) 235423

(51) Int. Cl. H04L 29/06

(52) U.S. Cl. CPC H04L 63/1416; H04L 63/1483

(57) ABSTRACT

The present invention relates to a method of providing an automated reaction to malicious polymorphic messages, comprising the steps of: a) applying a handling process on non-reported messages for detecting existing polymorphic messages that are maliciously similar to one or more messages that are classified as suspicious, thereby enabling to define the detected non-reported polymorphic messages as suspicious; and b) applying mitigating actions to neutralize said suspicious non-reported detected messages.

### FIELD OF THE INVENTION

The present invention relates to the field of Internet security. More particularly, the invention relates to a method of detecting and automatically responding to polymorphic messages-based malicious attacks such as phishing and spear-phishing attacks, especially attacks that are designed to change conveyed messages in a way that is meant to bypass standard signature based solutions (i.e. polymorphism)

### BACKGROUND OF THE INVENTION

As more users are connected to the Internet and conduct their daily activities electronically, their electronic communication means, such as e-mail accounts, mobile devices (e.g., via SMS, WhatsApp or other application for communicating messages) and the like, have become the target of malicious attempts to install malicious code/software, acquire sensitive information such as usernames, passwords, credit card details, etc. For example, phishing and spear-phishing attacks may target a specific organization, seeking unauthorized access to confidential data for financial gain, trade secrets or military information. One particularly dangerous type of phishing/spear-phishing directs users to perform an action, such as opening an e-mail attachment, e.g., opening an attachment to view an “important document” might in fact install malicious computer software (i.e., spyware, a virus, and/or other malware) on the user's computer, or following (e.g., using a cursor controlled device or touch screen) an embedded link to enter details at a fake website, e.g. the website of a financial institution, or a page which requires entering financial information, the look and feel of which are almost identical to the legitimate one. Attempts to deal with the growing number of reported phishing incidents include legislation, user training, public awareness, and technical security measures.

Because of the ever-growing methods and attempts to fraudulently obtain this type of information, there is a constant need to provide solutions that will not just generate alerts (e.g., SIEM tools, syslog facility) but will deal with (i.e. quarantine/move/disable the potential malicious parts in the body of the message, e.g., in an email message—disable the links/attachments) the attack for other potential victims when a phishing attempt is suspected, thereby mitigating the phishing attack. In particular, when the message is altered and manipulated across different recipients to avoid signature and exact match comparison and detection.

In case of alert, the alert might contain actionable items, such as signatures, to be published to other network/endpoint devices/solutions such as IPS/Spam monitoring service Filter/Web Gateway/Endpoint Detection and Remediation solution or any other cloud based solution or service in order to mitigate the attack. It is an object of the present invention to provide a method and related means to achieve this goal.

In case of system-wide automated response, all potentially malicious messages can be dealt with as described above.

It is an object of the present invention to provide a system capable of mitigating polymorphic message based attacks.

Other objects and advantages of the invention will become apparent as the description proceeds.

### SUMMARY OF THE INVENTION

The present relates to a method of detecting and automatically responding to polymorphic messages-based malicious attacks, comprising the steps of: a) applying a handling process on non-reported messages for detecting existing polymorphic messages that are maliciously similar to one or more messages that are classified as suspicious, and accordingly defining the detected non-reported polymorphic messages as suspicious; and b) applying mitigating actions to neutralize said suspicious non-reported detected messages.

According to an embodiment of the invention, the method further comprises assigning an awareness level for at least one individual user, and classifying a message as suspicious, whenever a calculation of respective awareness levels of one or more individual users who reported said message or a similar message as suspicious is above a predetermined threshold.

According to an embodiment of the invention, the handling process on non-reported messages is defined by enforcing rules and actions based on the awareness level assigned to each individual user and the context of the message.

According to an embodiment of the invention, the method further comprises collecting user behavior/activities on existing messages, thereby applying the mitigating actions in case one or more of the non-reported messages will be defined as suspicious or malicious message after a user has activated such message.

According to an embodiment of the invention, the method further comprises continuously inspecting incoming/existing messages according to predefined rules that define what is allowed or disallowed for each user based on the awareness level and the context of the message.

According to an embodiment of the invention, the method further comprises continuously checking for message status change.

According to an embodiment of the invention, the method further comprises allowing setting restrictions/rules for each individual user based on the awareness level of this user, thereby enabling to apply operations/actions on each received message for that user.

According to an embodiment of the invention, the awareness level for each individual user is defined either according to the response of each user in accordance with the user's reaction to previous suspicious messages.

According to an embodiment of the invention, the handling process comprises:
extracting features and properties from a message that is currently reported as suspicious, wherein the extraction include any extractable data from the message's structure, content and metadata;
creating signatures based on said extracted features and properties; and
comparing said extracted features and properties and said signatures to suspicious messages reported by other sources and/or users;
calculating a message overall score, such that if a calculated overall score is above a predefined threshold, defining said currently reported messages as a suspicious message, wherein each message feature and property have a predefined, configurable, score, being added to a previous calculated score, being part of the overall message score in terms of similarity.

According to an embodiment of the invention, the method further comprises scanning relevant message features/properties for extraction by using third party/external sources.

According to an embodiment of the invention, the method further comprises enabling to communicate with one or more sources in order to receive and send data about suspicious messages.

According to an embodiment of the invention, the one or more sources are third party and/or other sources that include data related to malicious messages, their content or their origin.

According to an embodiment of the invention, the malicious polymorphic messages are forms of polymorphic spear-phishing or phishing attacks.

According to an embodiment of the invention, messages are classified as suspicions whenever at least one of the message properties is found to be malicious by other malicious detection tools or sources.

According to an embodiment of the invention, the method further comprises the message properties are selected from the group consisting of links, attachment, domain, IP address, subject, body, metadata or combination thereof.

According to an embodiment of the invention, the method further comprises the malicious detection tools or sources are file/URL scanners such as Antivirus/Sandbox solution or any other information received from inside/outside source of the domain such as URL/file reputation sources.

According to an embodiment of the invention, the handling process on non-reported messages is defined by enforcing rules and actions based on the awareness level assigned to each individual user and the context of the message.

In another aspect, the present invention relates to a system of mitigating malicious attacks, comprising:
A message handling module for applying a handling process on non-reported messages for detecting existing polymorphic messages that are maliciously similar to one or more messages that are classified as suspicious, in order to define the detected non-reported polymorphic messages as suspicious; and
A mitigation module for applying mitigating actions to neutralize said suspicious non-reported detected messages.

According to an embodiment of the invention, the system further comprises communication means adapted to retrieve/receive data from one or more external sources for classifying messages as suspicious.

In yet another aspect, the present invention relates to a system, comprising:
a) at least one processor; and
b) a memory comprising computer-readable instructions which when executed by the at least one processor causes the processor to execute a process for mitigating messages-based malicious attacks, wherein the process:
   applies a handling process on non-reported messages for detecting existing polymorphic messages that are maliciously similar to one or more messages that are classified as suspicious, in order to define the detected non-reported polymorphic messages as suspicious;
   applies mitigating actions to neutralize said suspicious non-reported detected messages.

According to an embodiment of the invention, the process classifies a message as suspicious, whenever the calculation of the respective awareness levels of one or more individual users and/or sources that reported said message as suspicious is above a threshold level.

In a further aspect, the present invention relates to a non-transitory computer-readable medium comprising instructions which when executed by at least one processor causes the processor to perform the method of the present invention.

### BRIEF DESCRIPTION OF THE DRAWINGS

In the drawings:

FIG. 1 schematically illustrates a system in which the present invention may be practiced, in accordance with one embodiment;

FIGS. 2A and 2B are exemplary screen layouts generally illustrating the implementation of a report button for suspicious email messages;

FIG. 3 is a flow chart illustrating a suspicious message handling process, according to an embodiment of the invention; and

FIG. 4 is a flow chart illustrating an email inspection process, according to an embodiment of the invention.

### DETAILED DESCRIPTION OF THE INVENTION

Throughout this description the term “message” is used to indicate an electronic form of exchanging digital content from an author to one or more recipients. This term does not imply any particular messaging method, and the invention is applicable to all suitable methods of exchanging digital messages such as email, SMS, Instant Messaging (IM), Social Media Websites and the like. The term “polymorphic” is used to indicate a plurality of content items (e.g. email messages) that are visually/textually/contextually unequal, although that essentially contain similar malicious contents, such as a link to a hazardous IP or a downloadable attachment containing a virus, or is luring the victim to response with data that might lead to an account being compromise for instance

Reference will now be made to several embodiments of the present invention, examples of which are illustrated in the accompanying figures. Wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

The following discussion is intended to provide a brief, general description of a suitable computing environment in which the invention may be implemented. While the invention will be described in the general context of program modules that execute in conjunction with an application program that runs on an operating system on a personal computer, those skilled in the art will recognize that the invention may also be implemented in combination with other computer systems and program modules.

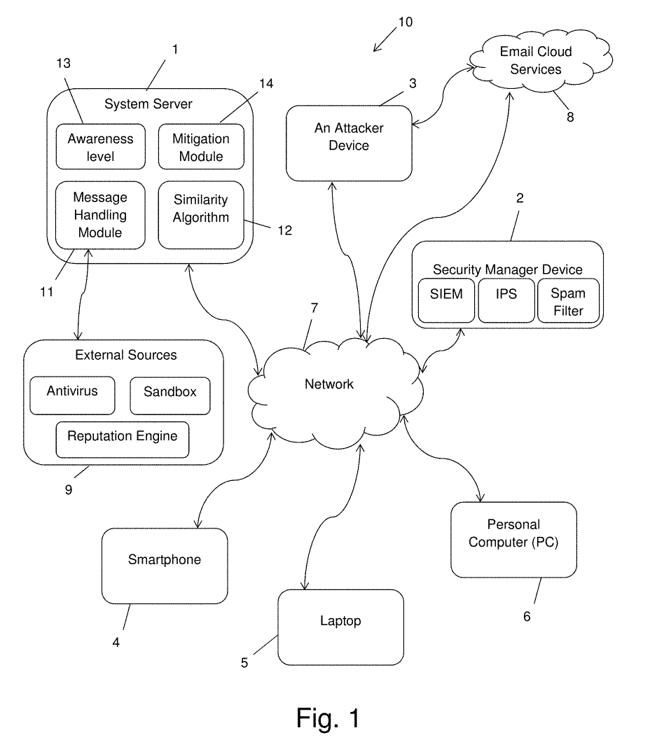

FIG. 1 schematically illustrates a system 10 in which the present invention may be practiced, in accordance with an embodiment. In system 10, network devices or network services such as those indicated by numerals 1, 2, 3 and 8 are communicatively coupled to computing devices 4, 5 and 6 via a network 7. The number of devices is exemplary in nature, and more or fewer number of devices or network services may be present.

A computing device may be one or more of a client, a desktop computer, a mobile computing device such as a smartphone, tablet computer or laptop computer, and a dumb terminal interfaced to a cloud computing system. A network device may be one or more of a server (e.g., a system server as indicated by numeral 1), a device used by a network administrator (as indicated by numeral 2), a device used by an attacker (as indicated by numeral 3), a cloud service (e.g., an email cloud service as indicated by numeral 8), and external sources that can be used as a data source from which information about malicious messages and/or their content (file/URL) can be retrieved, such as antivirus, sandbox, reputation engines or other malicious detection tools or sources (as indicated by numeral 9). In general, there may be very few distinctions (if any) between a network device and a computing device. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

According to an embodiment of the invention, at least one individual user (e.g., of a computer device) is assigned with an awareness level that may represent the skills and/or abilities of the user to identify malicious attack attempts in an electronic messaging environment, for example the ability to identify possible phishing attacks. The awareness level for each user can be set automatically according to his success/failure rate to report targeted electronic messages based attacks in the past when they happened, manually by a system administrator or other authorized person, or a combination thereof. For example, the system administrator might apply a simulated attack program to determine the user awareness level. The awareness level might change over time based on the user performance in the simulated attack program and/or the day-to-day experience, or manually by a system administrator or other authorized person.

For example, if the user were reporting an email as suspicious and it turned out to be an actual targeted attack, based on other users reports or an expert report, the user awareness level will be leveled up. On the other hand, if a suspicious email was residing in the user mailbox and the user fails to report about it, and it finally turned out to be an actual malicious one or a simulated one as explained above, the user awareness level may remain the same or might be even reduced to a lower awareness level.

According to an embodiment of the invention, the communication between computer devices and system's server may be encrypted, e.g., with asymmetric keys, symmetric key, pre-shared or other encryption methods.

According to an embodiment of the invention, system server 1 may include the following modules: an email handling process module 11, a similarity algorithm module 12 and an awareness level module 13 for setting the awareness level of each mailbox user as will be described in further details hereinafter, a mitigation module 14 to be responsible for reacting to polymorphic attacks and integrating with cloud/on-premise security services and appliances like SIEM and EOP in order to mitigate phishing attacks on the network gateway/cloud level before reaching endpoint and or other server devices inside the company network, and for other mitigation decisions regarding suspicious messages, both automated decisions and preconfigured ones.

Awareness Levels

The awareness levels may include two or more different levels, such as the followings:
Easy Clicker—an employee that repeatedly fall victim to mock phishing attacks launched by the system;
New employee/Newbie;
Novice;
Intermediate;
Advanced;
Expert.

Scoring Based Phishing Message Report

Awareness levels may be used in computing a likelihood that a message is a real phishing attack, to classify whether a message is a real phishing attack and further to control it (e.g., delete or disable this message). In one embodiment, an estimation of likelihood that a message is a real phishing attack (herein called an “awareness score” or “score” in short) is a calculation of the respective awareness levels of individual users who reported the message. For example, such calculation may consider the sum of the respective awareness levels of individual users who reported the message. In one embodiment, a determination as to whether to classify a message as a real phishing attack is based on comparing the score to a threshold value. For example, any message with a score that exceeds the threshold value is classified as a real phishing attack. In one embodiment, the threshold is an adjustable parameter, adjusted according to one or more of the number of false alarms and the number of missed detections.

Yet another parameter that may aid in the determination of a likelihood of a message as a real/suspicious phishing attack, is the result of an analysis (e.g., by scan) of the message properties (links/attachments/domains/IPs) by an external sources like antivirus/sandbox engines and or other reputation engines, for example, if the file attached to the message was found to be malicious by such external sources (e.g., one or more antivirus engine), the attack can be triggered immediately regardless the awareness score, other scan/reputation results (e.g. newly created domain) can be used as a parameter in the overall calculation of the message together with other user/scan reports/results.

Users at all awareness levels will be able to report suspicious messages. The system will collect their reports and score each message based on the reporting users' awareness level (and lack of reporting over time).

A message assigned with a score above a certain predefined threshold will be classified as malicious (e.g., a spear-phishing e-mail message) and will be controlled by the system (e.g., deleted/quarantined/disabled), according to security policies or administrator decisions. The thresholds, score per level, and control operations can be set at the system's server 1 via a dedicated user interface (herein “dashboard”), where the system administrator (or other authorized user) can choose to assign different policies for suspicious messages. For example, messages can be email messages that were reported as suspicious within an organization, or by different policies for suspicious email that were reported globally and were collected from different networks or other organizations (i.e., from third party or external sources).

According to an embodiment of the invention, the system's server 1 may support the following actions:
Handle reported messages;
Inspect incoming/existing messages;
Serve Configuration and Settings (Rules/Actions/Employee Data);
Check for message status change (if delayed, or suspended by rule for example).

Traps

“Traps” refers herein to those users who proved great skills in spotting malicious messages (e.g., spear-phishing emails) during previous attacks, or have been appointed by a security manager or administrator as ones regardless to their current awareness level, for instance, it can be set that each user assigned with an “Expert” awareness level is defined as a trap.

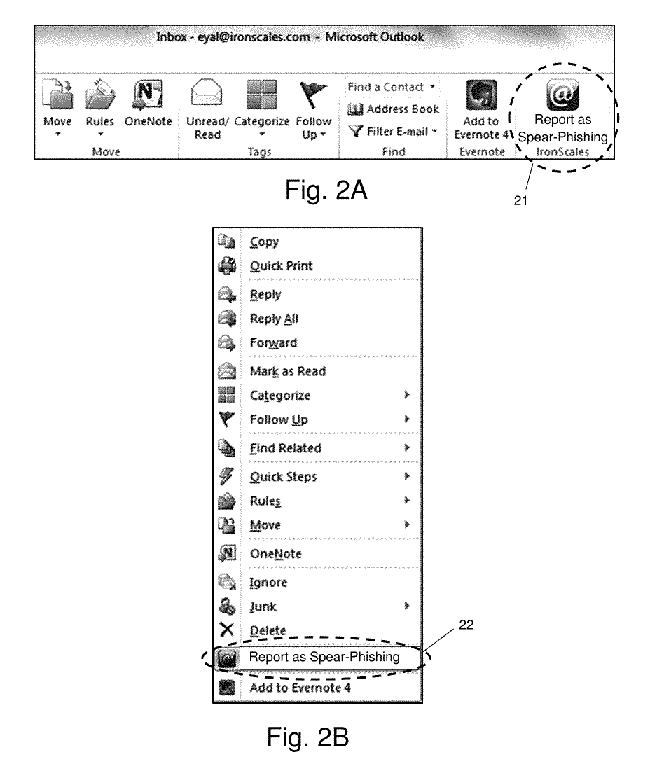

Traps may act as honeypots for malicious attacks, so that if an attacker has included such “trap” users in his attack target list, it is assumed that the attack will be intercepted and blocked by these users. Trap users may response quickly to an incoming malicious message (e.g., by activating a report action), so that their immediate response may lead eventually to the blockage or removal of the threat from other users who have received malicious message with similar properties. A trap user who is an employee at a specific organization or company may activate a report action on a suspicious email message, and accordingly similar email messages that have been received at other employees' mailboxes (of that organization or company) will be dealt with according that report action. For example, a report action can be implemented by variety of ways, such as in form of a clickable object provided inside the email or as an add-on to the email client (e.g., as indicated by numeral 21 in FIG. 2A and numeral 22 in FIG. 2B) or an email being forwarded to a predefined email address which being polled by the system (e.g., by link or attachment tracking as described hereinafter in further details), touch and swipe gestures, etc.

According to an embodiment of the invention, link tracking might be implemented by replacing the original link with dedicated link that will report back to the system and then redirect to the original link, or alternatively by collecting the information locally and send it to the system periodically or upon request.

Attachment tracking can be implemented by hooking the client system to track file operations like file open or file read or by registering to predefined client events or using any supported client API or by integrating any Rights Management System/Information Rights Management solution to put a code snippet/certificate inside the file which will report back to the system once the file was opened, previewed or read.

Moreover, While certain user inputs or gestures are described as being provided as data entry via a keyboard, or by clicking a computer mouse, optionally, user inputs can be provided using other techniques, such as by voice or otherwise.

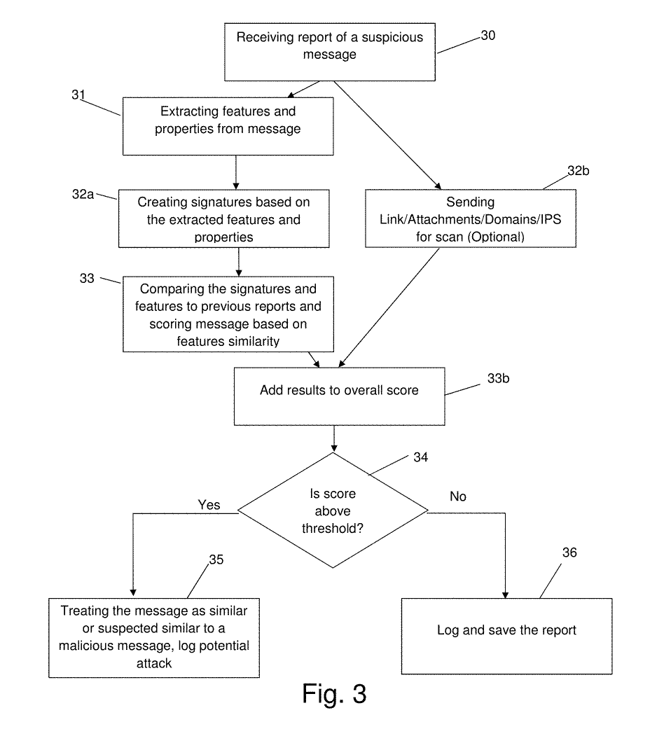

Due to the fact that different employees with various awareness scores can receive a polymorphic message, and expectedly not all of them are capable of positively detecting a suspicious message, upon reporting a message suspicious, all of the messages in the organization's network with the same malicious content are detected and dealt with. The suspicious message reaction process (e.g., deletion/disable/quarantine/inline/alert/resolve by SOC/Traps) is performed by using a similarity algorithm, since messages might vary between users, e.g., different greetings or sender name, words replacements or subsections being replaced or added, the content of a message can be completely different but coming from the same SMTP server as the suspicious one, or having the same malicious file attached, etc., as well as and any other technique that can be used to bypass spam filters or any other automated analysis system.
FIG. 3 is a flow chart illustrating a handling process for a suspicious message, according to an embodiment of the invention. The handling process involves the following steps: Receiving a message reported as suspicious (step 30);
Extracting from the reported message features and properties such as sender name and address, message headers, message subject, body, links—name and address, attachments type name, signatures and any other metadata that is extractable from the structure of the message, its content and metadata (step 31);
Creating signatures based on the above extracted features and properties (step 32a), for example, MD5/SHA 1 and CTPH (computing Context Triggered Piecewise Hashes such as FuzzyHash), the signatures can be set on any subset of the message features, for example, the CTPH signature can be created using the message subject and body.
Comparing the signatures and features to previous reports (step 33), and scoring the message based on features similarity, for example, same sending name or address, same origin SMTP server or same SMTP servers path, same links name and addresses or same attachments filename or signature (Hash or FuzzyHash), or any other feature similarity that might indicate that the messages are basically the same message with some changes. Each feature has a predefined, configurable, score, that is added (step 33) to the overall score of the message.
Optional additional steps comprise scanning relevant properties (links/attachments/domains/IPs) using third party/external sources (step 32b), and adding the scan results to the message overall score (step 33b).
If the message's overall score is above a predefined threshold (step 34), the message is treated as suspicious (step 35). For example, if the FuzzyHash compare score is above a predefined threshold the messages will be treated as similar or suspected similar. Otherwise, the message it treated as a regular message, i.e. logged and saved (step 36).

Additional steps for treating polymorphic messages comprise:
Adding the current reported message score to previous similar messages;
Checking the sum of each similar message score against the threshold; and
Trigger an attack if the threshold was reached.
If the current report is similar to previous reports and the overall score is above the thresholds the email will be treated as malicious.

According to an embodiment of the invention, authorized persons such as a security manager/Traps users/Security Operation Center (SOC) Team are able to resolve pending issues using a resolution center, by receiving notification (e.g., an email with actionable links) or by using any other resolving mechanism provided.

Messages marked as malicious may or may not be deleted according to the predefined settings, for example, in case the message was marked as malicious, the security manager might decide to suspend/disable/put aside the alert, the security manager might also decide not to delete messages if not reported by any top level user (i.e., user assigned with a relatively high awareness level or as “trap”) although reached the threshold. For example, in that case the message will be set in pending status and will wait for high level/security manager/SOC team resolution, based on the configuration and settings.

Messages marked as pending resolution appear in a dedicated user interface (herein dashboard, SIEM or alike) or are sent to a predefined list of resolvers by email or any other means. The resolvers are able to investigate the message, decide whether it is a malicious or not, and report back to the system by using the dashboard or by clicking a link that appears in the message or by forwarding his resolve to a predefined address or by any other API the system may introduce or be integrated with.

According to an embodiment of the invention, the system writes and keeps logs for every event, e.g. new reports about suspicious messages, pending or deleted messages, etc., so it will be possible to collect and aggregate these logs with a Security Information and Event Management (SIEM) service/product, for real time alerts and analysis by an expert team (i.e., SOC).

Skill Based Message Restrictions

According to an embodiment of the invention, the system allows an authorized user (e.g., security manager) to set restrictions/rules/operations on received messages for a specific user based on the awareness level of that specific user as proven in previous attacks or as set manually. For example, a security manager at a specific organization can set specific restrictions/rules/operations to an email account of an individual employee at that organization based on the awareness level of that employee.

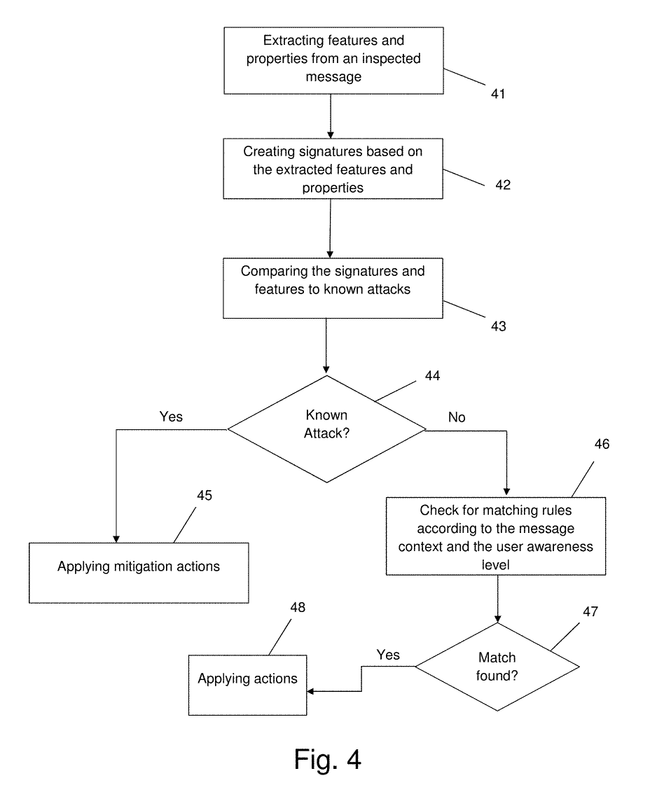

FIG. 4 is a flow chart illustrating a message inspection process, according to an embodiment of the invention. The inspection process may involve the following steps:
Extracting features and properties from an inspected message (step 41);
Creating signatures based on the extracted features and properties (step 42);
Comparing the extracted signatures and features to signatures of known attacks (step 43);
If the attack is known (step 44), applying mitigation actions (step 45);
If the attack is not known, checking for matching rules according to the message context and the user awareness level (step 46). If matched rules are found (step 47), applying relevant action (step 48).

For example, a security manager of a company may define what is allowed or forbidden by an employee of that company based on a received email message and the awareness level of that employee. In some embodiments, the security manager may define certain operations to be done upon each new email received or handled; such operation (e.g., the applied action in step 48) may include one or more of the following tasks:
deleting the message;
disabling links/attachments;
quarantining or moving the message to a different location;
queuing/delaying the message until investigated by higher skill rank;
adding message/alert/hints/guidance or other informative/hazard content into
the message in any suitable form, such as textual, visual and/or audible forms (e.g., text, image, video file, audio file);
marking the message or its preview with flags or custom icons, colors or any other visual sign;
sending attachment/links for deeper/longer/manual scanning and analysis;
replacing links name with target address;
highlighting links target domains;
adding inline message with useful information about the message to aid decision (for example—sender address/domain); and/or
executing any other operation that might block a potential phishing/spear-phishing attack.

All the above will be better understood through the following illustrative and non-limitative rules examples:

User accounts of employees at a specific organization may be assigned with awareness level from one of the following rank categories: “easy clickers”, “newbies”, “novice” and “intermediate”, where “easy clickers” defines the lowest ranked users and “intermediate” defines the highest ranked users with respect to the awareness level. The restrictions for each category can be set as follows:
“Easy Clicker” or “Newby” employees are not allowed to receive emails with an attachment (specific extensions or all) from outside the organization network/untrusted or unknown source;
Emails with attachment from outside the organization network/untrusted or unknown source (i.e., first email ever from this sender/sending domain) addressed to “Easy Clicker” or “Newby” employees will be delivered in delay in order to ensure that a higher awareness level user will not marked it as suspicious/malicious and an alert text will be inlined;
“Novice” and “Intermediate” are not allowed to click on links leading to different address from what appears in the link name;
“Easy Clickers” to “Novice” will receive a specific guiding text inside emails with links/attachments to help them to handle the e-mail and validate its authenticity.
“Easy Clickers” will receive hints, as an inline text for example, about the real sender address, link names will be replaced with real target text (URL and Domain), and hints about suspicious mismatch between sender address and target links.

A schematic flow chart of an illustrative system operating in accordance with one embodiment of the invention, which employs a system's server and a client computer device flows, is shown in FIG. 1. The operation of this illustrative system is self-evident from the flow chart and this description and, therefore, is not further discussed for the sake of brevity.

The system manager or other authorized person will be able to set the rules and actions by using the user interface (dashboard) or by using any API given by the system.

The rules will define what is allowed or disallowed for users/employees based on their awareness level and the context of the message.

Every message, either new or existing, will be checked against the current set of rules and actions to decide on the proper action (step 46 in FIG. 4). The trigger to check an existing message can be activated by one or more of the following events:
the message being selected in the navigation pane;
the message is being previewed, read, or opened; or
any other trigger that might indicate that the message is being handled by the user.

In case the message context matches a rule set for the user awareness level, the action will be executed according to the configuration and settings (step 48 in FIG. 4).

Incident Response Aiding

The system collects events such as clicks and opening of links and attachments in existing or received messages, so if an existing message will be set as malicious later on, for example, if reported by a high ranked user/Trap or by reaching the predefine threshold, the security manager will know who exactly took action on this malicious message and is now potentially infected with malicious Trojan/virus or any other malicious code.

The system's dashboard/API allows the security manager to receive this information for every active undergoing attack or past attacks, for example, if an email was reported and set as malicious by the system, the security manager will be able to extract a list of all employees that took action, e.g. clicked on a link that appears in the email or opened an attachment in the email, before and after the email was set as malicious, and act upon.

As will be appreciated by the skilled person the arrangement described in the figures results in a system which is capable of mitigating malicious attacks, in particular message based attacks.

Embodiments of the invention may be implemented as a computer process (method), a computing system, or as an article of manufacture, such as a computer program product or a non-transitory computer-readable media. The computer program product may be a computer storage media readable by a computer system and encoding a computer program of instructions for executing a computer process on the computer and network devices. The computer program product may also be a propagated signal on a carrier readable by a computing system and encoding a computer program of instructions for executing a computer process.

The functions described hereinabove may be performed by executable code and instructions stored in computer readable medium and running on one or more processor-based systems. However, state machines, and/or hardwired electronic circuits can also be utilized. Further, with respect to the example processes described hereinabove, not all the process states need to be reached, nor do the states have to be performed in the illustrated order. Further, certain process states that are illustrated as being serially performed can be performed in parallel.

The terms, “for example”, “e.g.”, “optionally”, as used herein, are intended to be used to introduce non-limiting examples. While certain references are made to certain example system components or services, other components and services can be used as well and/or the example components can be combined into fewer components and/or divided into further components. The example screen layouts, appearance, and terminology as depicted and described herein, are intended to be illustrative and exemplary, and in no way limit the scope of the invention as claimed.

All the above description and examples have been given for the purpose of illustration and are not intended to limit the invention in any way. Many different methods of message analysis, electronic and logical modules and data sources can be employed, all without exceeding the scope of the invention.

1. A method of providing an automated response to malicious polymorphic messages, comprising the steps of:
a. Applying a handling process on non-reported messages for detecting existing polymorphic messages that are maliciously similar to one or more messages that are classified as suspicious, thereby enabling to define the detected non-reported polymorphic messages as suspicious; and
b. applying mitigating actions to neutralize said suspicious non-reported detected messages.

2. A method according to claim 1, further comprising assigning an awareness level for at least one individual user, and classifying a message as suspicious, whenever a calculation of respective awareness levels of one or more individual users who reported said message or a similar message as suspicious is above a predetermined threshold.

3. A method according to claim 2, wherein the handling process on non-reported messages is defined by enforcing rules and actions based on the awareness level assigned to each individual user and the context of the message.

4. A method according to claim 1, further comprising collecting user behavior/activities on existing messages, thereby applying the mitigating actions in case one or more of the non-reported messages will be defined as suspicious or malicious message after a user has activated such message.

5. A method according to claim 2, further comprising continuously inspecting incoming/existing messages according to predefined rules that define what is allowed or disallowed for each user based on the awareness level and the context of the message.

6. A method according to claim 1, further comprising continuously checking for message status change.

7. A method according to claim 2, further comprising allowing to set restrictions/rules for each individual user based on the awareness level of this user, thereby enabling to apply operations/actions on each received message for that user.

8. A method according to claim 2, wherein the awareness level for each individual user is defined either according to the response of each user in accordance with the user's reaction to previous suspicious messages.

9. A method according to claim 1, wherein the handling process comprises:
a) extracting features and properties from a message that is currently reported as suspicious, wherein the extraction include any extractable data from the message's structure, content and metadata;
b) creating signatures based on said extracted features and properties; and
c) comparing said extracted features and properties and said signatures to suspicious messages reported by other sources and/or users;
d) calculating a message overall score, such that if a calculated overall score is above a predefined threshold, defining said currently reported messages as a suspicious message, wherein each message feature and property have a predefined, configurable, score, being added to a previous calculated score, being part of the overall message score in terms of similarity.

10. A method according to claim 9, further comprising scanning relevant message features/properties for extraction by using third party/external sources.

11. A method according to claim 1, further comprising enabling to communicate with one or more sources in order to receive and send data about suspicious messages.

12. A method according to claim 11, wherein the one or more sources are third party and/or other sources that include data related to malicious messages, their content or their origin.

13. A method according to claim 1, wherein the malicious polymorphic messages are forms of polymorphic spear-phishing or phishing attacks.

14. A method according to claim 1, wherein messages are classified as suspicions whenever at least one of the message properties is found to be malicious by other malicious detection tools or sources.

15. A method according to claim 14, wherein the message properties are selected from the group consisting of links, attachment, domain, IP address, subject, body, metadata or combination thereof.

16. A method according to claim 14, wherein the malicious detection tools or sources are file/URL scanners such as Antivirus/Sandbox solution or any other information received from inside/outside source of the domain such as URL/file reputation sources.

17. A system of mitigating malicious attacks, comprising:
a) A message handling module for applying a handling process on non-reported messages for detecting existing polymorphic messages that are maliciously similar to one or more messages that are classified as suspicious, in order to define the detected non-reported polymorphic messages as suspicious; and
b) A mitigation module for applying mitigating actions to neutralize said suspicious non-reported detected messages.

18. A system according to claim 16, further comprising communication means adapted to retrieve/receive data from one or more external sources for classifying messages as suspicious.

19. A system, comprising:
a) at least one processor; and
b) a memory comprising computer-readable instructions which when executed by the at least one processor causes the processor to execute a process for mitigating messages-based malicious attacks, wherein the process:
applies a handling process on non-reported messages for detecting existing polymorphic messages that are maliciously similar to one or more messages that are classified as suspicious, in order to define the detected non-reported polymorphic messages as suspicious;
applies mitigating actions to neutralize said suspicious non-reported detected messages.

20. A system according to claim 19, wherein the process classifies a message as suspicious, whenever the calculation of the respective awareness levels of one or more individual users and/or sources that reported said message as suspicious is above a threshold level.
